(19) United States
(12) Patent Application Publication
(10) Pub. No.: US 2011/0234513 A1
(43) Pub. Date: Sep. 29, 2011

(54) ELECTRONIC PAPER DISPLAY DEVICE WITH TOUCH FUNCTION

(75) Inventors: CHUN-WEI PAN, Tu-Cheng (TW); KUAN-HONG HSIEH, Tu-Cheng (TW); LI-JIA YAN, Shenzhen City (CN)

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/966,878

(22) Filed: Dec. 13, 2010

(30) Foreign Application Priority Data
Mar. 26, 2010 (CN) 201010133438.9

(51) Int. Cl. G06F 3/041; G09G 3/34

(52) U.S. Cl. 345/173; 345/107

(57) ABSTRACT

An E-paper display device with touch sensing function includes a composite transparent electrodes layer including at least one layer of touch electrodes responding to a touch, a pixel electrode, and an electrophoretic medium contacting the composite transparent electrodes layer and arranged between the composite transparent electrodes layer and the pixel electrode. One of the at least one layer of touch electrodes forms a display layer with the pixel electrode and the electrophoretic medium. A driving circuit configured to detect the location of a user touch on the composite transparent electrodes layer and drive the electrophoretic medium layer for displaying content. With the use of the composite transparent electrodes layer, the light propagation efficiency can be effectively improved, and the manufacturing technology is simplified.

### BACKGROUND

1. Technical Field

The present disclosure relates to electronic-paper (E-paper) display devices, especially to an E-paper display device with touch function.

2. Description of Related Art

For use as a E-paper display, a electrophoretic display is preferred over a liquid crystal display (LCD) because of a better reflectivity and contrast ratio. In addition, the electrophoretic display has low power consumption since it has bistable characteristic and can maintain content without needing a continuously applied voltage. The electrophoretic display is widely used for the screen of cell phone, E-book, PDA etc.

A touch panel has been arranged on the electrophoretic display to employ a touch function. The touch panel is stacked on a surface of the electrophoretic display by a thin binder film. However, such a structure tends to reduce the reflectivity ratio of the electrophoretic display. Furthermore, assembling of the touch panel and electrophoretic display needs to be carried out in a sterile room for quality consideration.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of an E-paper display device according to a first embodiment.

FIG. 2 is a block diagram of the E-paper display device of FIG. 1.

FIG. 3 is a flowchart of a control method applied in the E-paper display device of FIG. 1.

FIG. 4 is a schematic view of an E-paper display device according to a second embodiment.

### DETAILED DESCRIPTION

The disclosure, including the accompanying, is illustrated by way of example and not by way of limitation. It should be noted that references to “an” or “one” embodiment in this disclosure are not necessarily to the same embodiment, and such references mean at least one.

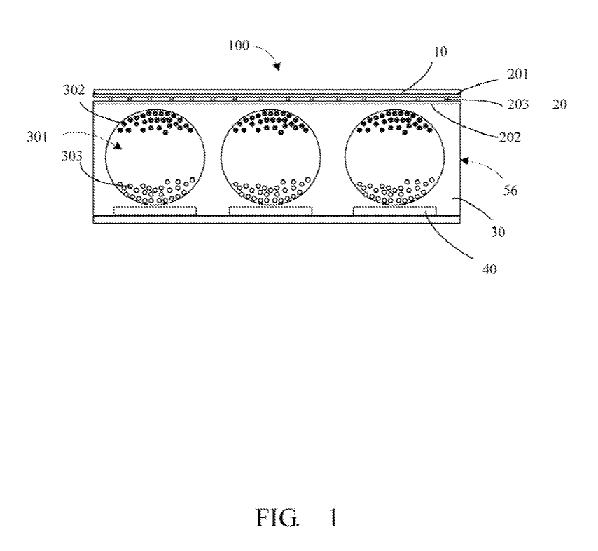

Referring to FIG. 1, an E-paper display device 100 according to a first embodiment is disclosed. The E-paper display device 100 includes a covering layer 10, a composite transparent electrodes layer 20, an electrophoretic medium 30 and a pixel electrode 40.

The covering layer 10 is arranged on the surface of the E-paper display device 100 to protect the display from being scratched. The covering layer 10 may be a transparent film of high light propagation efficiency.

In the first embodiment, the electrophoretic medium 30 is described as microcapsule electrophoretic medium with bistable characteristic. The electrophoretic medium 30 includes a plurality of microcapsules 301 containing electronic ink with first electrophoretic particles 302 with black pigment and second electrophoretic particles 303 with white pigment.

The composite transparent electrodes layer 20 includes a first touch electrode 201, a second touch electrode 202 and a plurality of spacers 203 arranged between the first touch electrode 201 and the second touch electrode 202 to separate the first touch electrode 201 from the second touch electrode 202. The first touch electrode 201 and the second touch electrode 202 may be an electrically conductive and resistive layer made with indium tin oxides (ITO) film. The spacers 203 may be an array of transparent and insulating plastic having a thickness about 10˜40 micrometer. The composite transparent electrodes layer 20 includes two modes: a touch mode and a driving mode. When the surface of the E-paper display device 100 is touched under the touch mode, the two layers of touch electrodes 201, 202 are pressed together, the current variation of the first touch electrode 201 and the second touch electrode 202 indicates the location of the touch. In this embodiment, the E-paper display device 100 achieves the touch function by applying a resistive touch panel consisting of the first touch electrode 201, the second touch electrode 202, and the spacers 203.

The second touch electrode 202 further contacts with the electrophoretic medium 30, and acts as a common electrode layer under the driving mode. The second touch electrode 202, the electrophoretic medium 30 and the pixel electrode 40 forms a display layer 56. An adhesive layer (not shown), adheres the pixel electrode 40 to the electrophoretic medium 30. The pixel electrode 40 includes a plurality of Thin-film transistors (TFTs), the pixel electrode 40 is used to generate a pixel voltage supplied through the TFT to generate an electric potential difference relating to the common voltage supplied to the second touch electrode 202 (the common electrode). Under the driving mode, the electric potential applied to the second touch electrode 202 and the pixel electrode 40 causes the first electrophoretic particles 302 and the second electrophoretic particles 303 to move to the electrodes attracting those particles, thereby displaying content such as an image.

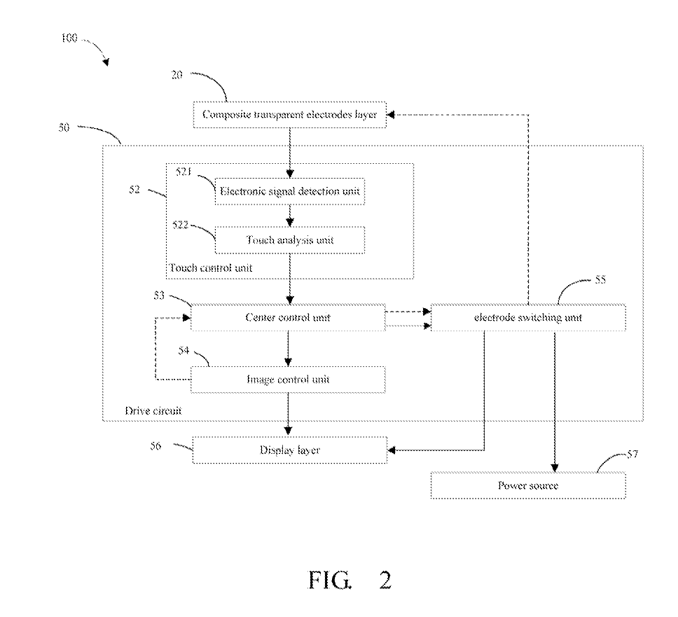

Referring to FIG. 2, the E-paper display device 100 further includes a power source 57 and a drive circuit 50 used to detect the location of the touch on the composite transparent electrodes layer 20 and drive the display layer 56 for displaying the content.

The driving circuit 50 includes a touch control unit 52, a center control unit 53, an electrode switching unit 55 and an content control unit 54. The touch control unit 52 is connected between the composite transparent electrode layer 20 and the center control unit 53. The content control unit 54 is connected between the display layer 56 and the center control unit 53. The electrode switching unit 55 is connected to the center control unit 53, the composite transparent electrode layer 20 and the display layer 56.

The electrode switching unit 55 is used to switch the composite transparent electrodes layer 20 between the touch mode and the driving mode. The power source 57 is connected to the composite transparent electrodes layer 20 under the touch mode, and to the second touch electrode 202 and the pixel electrode 40 under the driving mode. The electrode switching unit 55 may be an electronic switching circuit including a metal oxide semiconductor field effect transistor (MOSFET).

The touch control unit 52 includes an electronic signal detection module 521 and a touch analysis module 522. The electronic signal detection module 521 is connected to the composite transparent electrodes layer 20. The power source 57 generates an electric field between the first touch electrode 201 and the second touch electrode 202. When the surface of the E-paper display device 100 is touched under the touch mode, the two layers of touch electrodes 201, 202 are pressed together, the current on the first touch electrode 201 and the second touch electrode 202 changes. The electronic signal detection module 521 detects and collects the current variation of the two layers of touch electrodes 201, 202, and sends the current variation data to the touch analysis module 522. The touch analysis module 522 identifies the location of the touch by analyzing the current variation data, and sends the data about the location of the touch to the center control unit 53.

The center control unit 53 identifies whether the content on the E-paper display device 100 needs to be changed according the location of the touch. If the content on the E-paper display device 100 needs to be changed, the center control unit 53 sends a first switching command to the electrode switching unit 55 and a driving signal to the content control unit 54. If the content on the E-paper display device 100 does not need to be changed, the center control unit 53 executes the command corresponding to the location of the touch, and the electronic signal detection module 521 keeps on detecting and collecting the current variation of the first touch electrode 201 and the second touch electrode 202. For example, when the location of the touch corresponds to the command “return to previous menu”, the center control unit 53 sends a first switch command to the electrode switching unit 55 and sends a driving signal to the content control unit 54, so that the E-paper display device 100 returns to the previous menu. If the location of the touch point corresponding to “turn the volume up”, the center control unit 53 just executes the command “turn the volume up” to turn up the volume of the E-paper display device 100.

After receiving the first switch command from the center control unit 53, the electrode switching unit 55 disconnects the connection between the power source 57 and the composite transparent electrodes layer 20 to remove the electric filed formed between the first touch electrode 201 and the second touch electrode 202. In addition, connects the power source 57 to the second touch electrode 202 and the pixel electrode 40, to switch the composite transparent electrodes layer 20 from the touch mode to the driving mode.

After the content control unit 54 receives the driving signal from the center control unit 53, the content control unit 54 controls the pixel voltage to change the optical state of the electrophoretic medium 30, to refresh the content on the E-paper display device 100.

The content control unit 54 sends a finished signal to the center control unit 53 when the refresh of the content on the E-paper display device 100 is completed, the center control unit 53 sends a second switching command to the electrode switching unit 55 according to the finished signal. After receiving the second switching command from the center control unit 53, the electrode switching unit 55 disconnects the connection between the power source 57 and the display layer 56 to remove the electric field formed between the second touch electrode 202 and the pixel electrode 40. Moreover, connects the power source 57 to the first touch electrode 201 and the second touch electrode 202, to switch the composite transparent electrodes layer 20 from the driving mode to the touch mode. The electronic signal detection module 521 starts to detect and collect the current variation of the first touch electrode 201 and the second touch electrode 202.

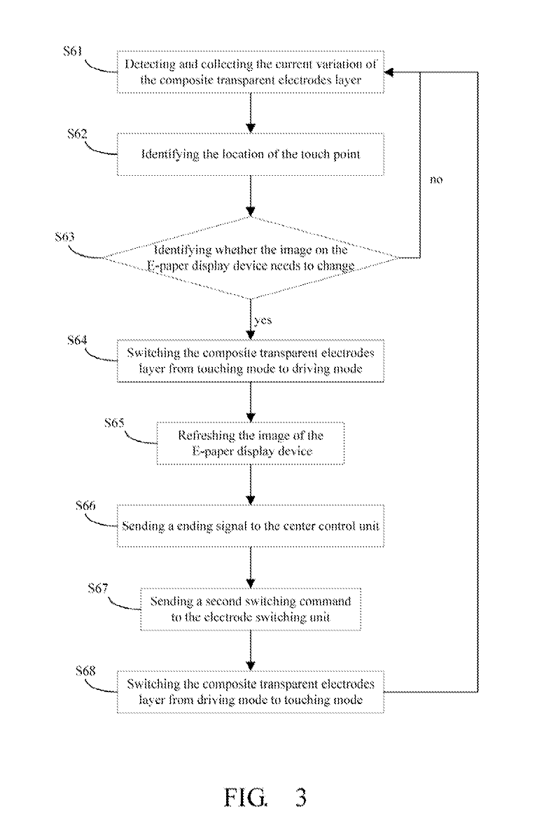

Referring to FIG. 3, a flowchart of a control method is applied in the E-paper display device 100.

In step S61, the electronic signal detection module 521 detects and collects the current variation of the first touch electrode 201 and the second touch electrode 202, and sends the current variation data to the touch analysis module 522.

In step S62, the touch analysis module 522 identifies the location of the touch by analyzing the current variation data sent by the electronic signal detection module 521, and sends the data about the location of the touch point to the center control unit 53.

In step S63, the center control unit 53 identifies whether the content on the E-paper display device 100 needs to be changed according the location of the touch. If so, the center control unit 53 sends a first switching command to the electrode switching unit 55, sends a driving signal to the content control unit 54, and the procedure goes to step S64; if not, the center control unit 53 executes the command corresponding to the location of the touch, and the procedure goes back to step S61.

In step S64, the electrode switching unit 55 switches the composite transparent electrodes layer 20 from the touch mode to the driving mode according the first switch command.

In step S65, the content control unit 54 controls the pixel voltage to change the optical state of the electrophoretic medium 30 according the driving signal, to refresh the content on the E-paper display device 100.

In step S66, the content control unit 54 sends a finish signal to the center control unit 53 when the refresh of the content on the E-paper display device 100 is completed.

In step S67, the center control unit 53 sends a second switching command to the electrode switching unit 55 according to the finish signal.

In step S68, the electrode switching unit 55 switches the composite transparent electrodes layer 20 from the driving mode to the touch mode according the second switch command, and the procedure goes back to step S61.

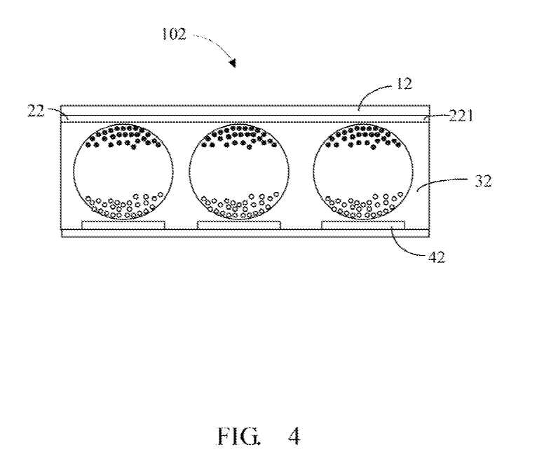

Referring to FIG. 4, an E-paper display device 102 according to a second embodiment is disclosed. The E-paper display device 102 includes a covering layer 12, a composite transparent electrodes layer 22, an electrophoretic medium 32 and a pixel electrode 42.

The second embodiment is similar to the first embodiment, the difference between the second embodiment and the first embodiment is that the composite transparent electrodes layer 22 just includes a layer of touch electrode 221. The composite transparent electrodes layer 22 also includes a touch mode and a driving mode. A small voltage is applied to the touch electrode 221, resulting in a uniform electrostatic field. When a conductor, such as a human finger, touches the surface of the E-paper display device 100, a capacitor is dynamically formed. The location of the touch can be determined indirectly from the change in the capacitance as measured from the four corners of the touch electrode 221. In the second embodiment, the E-paper display device 102 achieves the touch function by applying a surface capacitive touch panel including the touch electrode 221.

The touch electrode 221 also acts as a common electrode layer under the driving mode. The pixel voltage applied to the touch electrode 221 and the pixel electrode 42 causes the electrophoretic medium 32 to change optical state, thus to refresh the content on the E-paper display device 100.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. An E-paper display device with touch sensing function, comprising:
a composite transparent electrodes layer comprising at least one layer of touch electrodes responding to user touches;
a pixel electrode; and
an electrophoretic medium contacting the composite transparent electrodes layer and arranged between the composite transparent electrodes layer and the pixel electrode, one of the at least one layer of touch electrodes forming a display layer with the pixel electrode and the electrophoretic medium;
a power unit; and
a driving circuit configured to detect the location of a user touch on the composite transparent electrodes layer and drive the display layer for displaying content.

2. The E-paper display device of claim 1, wherein the at least one layer of touch electrodes are two and a plurality of spacers arranged between the two layers of the touch electrodes to separate the layers of the touch electrodes, which forms a resistive touch panel.

3. The E-paper display device of claim 2, wherein one of the two layers of the touch electrodes which contacts with the electrophoretic medium forms the display layer with the pixel electrode and the electrophoretic medium.

4. The E-paper display device of claim 1, wherein the composite transparent electrodes layer comprises one layer of the touch electrodes and forms a surface capacitive touch panel.

5. The E-paper display device of claim 1, wherein the pixel electrode comprises a plurality of thin-film transistors.

6. The E-paper display device of claim 1, wherein the electrophoretic medium is an electrophoretic ink with bistable characteristic.

7. The E-paper display device of claim 6, wherein the electrophoretic medium is a microcapsule electrophoretic medium.

8. The E-paper display device of claim 1, wherein the composite transparent electrodes layer comprises a touch mode and a driving mode, and the driving circuit comprises:
a touch control unit configured to detect the location of the user touch on the composite transparent electrodes layer;
a center control unit configured to identify whether content on the E-paper display device needs to be changed according the data about the location of the user touch sent by the touch control module;
an electrode switching unit configured to switch the composite transparent electrodes layer between the touch mode and the driving mode; and
a content control unit configured to control the pixel voltage to change the optical state of the electrophoretic medium, so as to refresh the content on the E-paper display device;
wherein if the content on the E-paper display device needs to be changed, the center control unit is further configured to send a first switching command to the electrode switching unit, and send a driving signal to the content control unit, the electrode switching unit is further configured to switch the composite transparent electrodes layer from the touch mode to the driving mode according to the first switching command, the content control unit controls the pixel voltage to refresh the content on the E-paper display device according to the driving signal.

9. The E-paper display device of claim 8, wherein the content control unit is further configured to send a finish signal to the center control unit when the refresh of the content on the E-paper display device is completed, the center control unit is further configured to send a second switching command to the electrode switching unit according to the finish signal, and the electrode switching unit is further configured to switches the composite transparent electrodes layer from the driving mode to the touch mode according to the second switching command.

10. The E-paper display device of claim 8, wherein the touch control unit comprises an electronic signal detection module configured to detect and collect the current variation of the composite transparent electrodes layer under the touch mode, and a touch analysis module configured to identify the location of the user touch by analyzing the current variation data.
